(19) United States
(12) Patent Application Publication
(10) Pub. No.: US 2026/0267556 A1
(43) Pub. Date: Sep. 10, 2026

(54) MEMORY DEVICE WITH COMMAND BLOCKING

(71) Applicants: ATI Technologies ULC, Markham (CA); Advanced Micro Devices, Inc., Santa Clara, CA (US)

(72) Inventors: Michael LITT, Ontario (CA); Yubin YAO, Santa Clara, CA (US)

(21) Appl. No.: 19/072,737

(22) Filed: Mar. 6, 2025

(51) Int. Cl. G06F 3/06

(52) U.S. Cl. CPC G06F 3/0659; G06F 3/0604; G06F 3/0673

(57) ABSTRACT

An electronic device includes a memory device that is able to block execution of commands. The memory device includes memory circuitry and control circuitry. The memory circuitry stores data. The control circuitry is connected to the memory circuitry. The control circuitry receives a first signal from a host device, and blocks execution of commands to the memory circuitry based on a parity error within the first signal.

### TECHNICAL FIELD

Examples of the present disclosure generally relate to a memory device that detect signal parity errors and block the execution of commands by the memory device based on detecting the parity errors.

### BACKGROUND

Memory circuitries are coupled with and controlled by memory controllers. The memory circuitries include memory devices that store data. Command and address signals are transmitted between the memory controllers and the memory circuitries to control the functionality of the memory circuities. The command and address signals include read commands and/or write commands. A read command is used to read data from the memory circuitries. A write command is used to write data to the memory circuitries.

Error checking is used to determine if errors are present within a command and address signal. Error checking includes parity checking. Parity checking is used to determine if a value of one or more bits associated with a command address signal has changed during transmission of the command and address signal. A memory circuitry combines (e.g., XORs) the bits of a command and address signal together to determine a parity value. If the value of the parity value differs from that of the expected parity value, an error is determined. When an error is detected, the error is reported from the memory circuitry to the memory controller. Based on the detection of the error signal, the memory controller may resend the previous command signal, or perform another action.

The error rate corresponds to the data rate of the memory circuitry. As the data rate of the memory circuitry increases, the error rate also increases. The frequency used to communicate the command and address signals increases as the data rate increases. As the frequency of the command and address signals increases, the corresponding signal integrity decreases due to physical limitations within the connections used to communicate the command and address signals. The decrease in command address signal integrity increases the number of errors that occurs, decreasing performance of the memory circuitries and the corresponding computer system. Further, in current implementations, when errors are detected the command and address signals, the memory circuitries are not prevented from executing commands. Accordingly, errors may occur within the data of the memory circuitries.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of an electronic device.

FIG. 2 illustrates a block diagram of an electronic device.

FIG. 3 illustrates a block diagram of a computer system.

FIG. 4 illustrates a flowchart of a method for detecting errors within a signal and mitigating the detected errors.

FIG. 5 illustrates a state diagram for the operation of a memory device.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Memory devices employ parity checking procedures to detect errors within received signals. For example, a memory device determines a value of a parity bit of a signal based on the bits of the signal. The memory device compares the determined parity bit to an expected parity bit. When the determined parity bit does match the expected parity bit, a parity error is determined. In some implementations, the memory device outputs an error signal to a host device (e.g., the host device the provided the command and address signal). Based on the error signal, the host device may indicate that a fatal error has occurred. However, while the host device indicates that a fatal error has occurred and that the parity error was determined, the memory device executes the corresponding command. Accordingly, the memory device may include errors. Further, as data rate of the memory circuitry increases, the frequency used to communicate signals between the host device and the memory device increases. As the frequency increases, physical limitations within the connection between the host device and memory device may decrease the corresponding signal integrity, increasing the number of errors that occurs. Accordingly, the performance of the memory device, and the corresponding electronic device, is decreased.

In the following, an improved signal error detection and mitigation process is described. As is described in greater detail in the following, based on the detection of a parity error, commands are blocked from being performed by the memory device. In one example, the memory device enters a command blocking period. In the command blocking period, the memory device is blocked (prevented) from executing commands, including the command associated with the parity error. In one or more examples, latency may exist within the memory device. The latency may be due to pipeline latency in the control circuitry (e.g., parity error checking circuitry). The latency may be one or more clock cycles. In one example, a received command is held within a buffer (or another element). A command is released when the command is determined to be error free, or the command is blocked when an error is detected.

At the completion of the command blocking period, the memory device is able to execute commands. Accordingly, reliability of the memory device, and the corresponding computer system is improved as errors corresponding to executing memory commands associated with a parity error are mitigated by blocking the execution of commands.

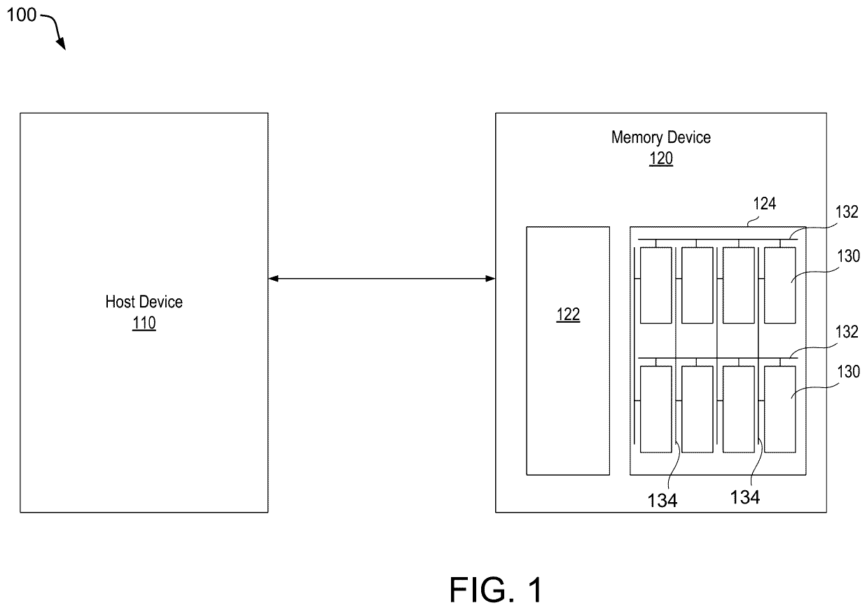

FIG. 1 illustrates electronic device 100, according to one or more examples. The electronic device 100 includes a host device 110 and a memory device 120. The host device 110 is connected to the memory device 120.

The host device 110 includes a memory controller and/or a processing device, among others. The processing device is a central processing unit (CPU) or a graphics processing unit (GPU), among others. The memory controller is used to communicate command address signals and data signals from the host device to the memory device 120.

The memory device 120 includes control circuitry 122 and memory circuitries 124. The control circuitry 122 receives command address signals and data signals from the host device 110, and processes the command signals and/or the data signals to the memory circuitries 124. In one example, the control circuitry 122 is part of an interface circuitry of the memory device 120. For example, the control circuitry 122 is part of the physical interface (PHY) circuitry of the memory device 120. In one example, the control circuitry 122 is part of memory controller circuitry or another circuit element of the memory device 120.

The memory circuitries 124 are used to store data and to provide the stored data to the host device 110. The control circuitry 122 provides the command and address signals and/or data signals to the memory circuitries 124 to store data and/or to provide stored data to the host device. In one example, the memory circuitries 124 include one or more memory elements (e.g., memory cells) 130. The memory elements are arranged in rows and columns. The memory elements 130 of a row are connected to a row bus 132. The memory elements 130 of a column are connected to a common column bus 134. In other examples, the memory elements 130 may be arranged in other configurations. In one example, an address of a command and address signal corresponds to a memory element within the memory circuitry, and an associated row bus and column bus.

In one example, the memory device 120 includes one or more vertically stacked and/or horizontally disposed memory dies. The memory dies include memory circuitries configured similar to the memory circuitries 124. In one or more examples, the memory device 120 is a high bandwidth memory (HBM) device. A high bandwidth memory device provides increased bandwidth and memory density as compared to conventional memory devices. In one such example, the memory device 120 includes up to 8-12 or more layers of dynamic random-access memory (DRAM) dies, or other memory devices, which are stacked (or connected in another way).

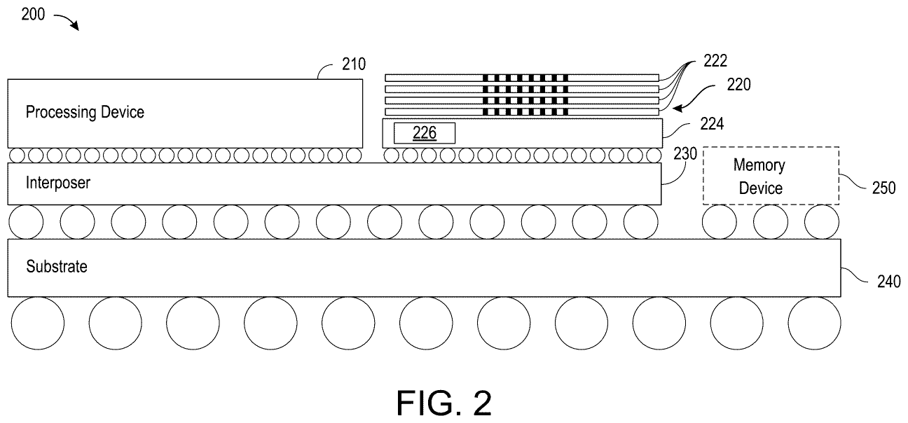

FIG. 2 illustrates an electronic device 200, according to one or more examples. The electronic device 200 is configured similar to the electronic device 100 of FIG. 1. The electronic device 200 includes a processing device 210, a memory device (e.g., a stacked memory device) 220, an interposer 230, and a substrate 240. The processing device 210 is a CPU or a GPU, among others. In one example, the processing device 210 is part of host device (e.g., the host device 110 of FIG. 1).

The memory device 220 is configured similar to the memory device 120 of FIG. 1. The memory device 220 is connected to the processing device 210 through traces and/or vias within the interposer 230. The interposer 230 may be a silicon interposer, an organic interposer, or an organic interposer with embedded silicone bridges, among others. In other examples, the memory device 220 is disposed on top of the processing device 210. In one example, the memory device 220 may be connected to other processing devices and/or an external device(s) via the interposer 230 and/or the substrate 240.

The substrate 240 may be referred to as a package substrate. The substrate 240 is connected to the interposer 230 via solder balls. In one or more examples, the interposer 230 is omitted and the memory device 220 and the processing device 210 are directly mounted to (e.g., disposed on) the substrate 240.

The memory device 220 includes a logic die 224 and one or more memory dies 222. The memory dies 222 are interconnected with each other. The memory dies 222 are vertically stacked (e.g., mounted) on the logic die 224. In one example, the memory dies 3222 are vertically stacked on each other and the logic die 224, forming a three-dimensional (3D) stack. In other examples, two or more of the memory dies 222 may be horizontally stacked with each other and/or the logic die 224.

The logic die 224 is connected (e.g., communicatively connected) with the memory dies 222. The logic die 224 includes one or more active and/or passive circuit elements to communicate signals (e.g., command and/or data signals) to and receive signals from the memory dies 222. The logic die 224 includes control circuitry 226. The control circuitry 226 is configured similar to and performs similar functions as the control circuitry 122 of FIG. 1. In one example, the control circuitry 226 is at least partially disposed within one or more of the memory dies 222. In one or more examples, the control circuitry 226 is disposed within each of the memory dies 222, and external to the logic die 224. In another example, the control circuitry 226 is at least partially disposed within one or more of the memory dies 222 and the logic die 224. The memory device 220 is a HBM device.

The electronic device 200 further includes a memory device 250. The memory device 250 is connected to at least one of the processing device 210 and the memory device 220. The memory device 250 may be a different memory type than that of the memory dies 222. In one example, the external memory device 250 is comprised of a memory structure that is faster and/or higher capacity than the memory structure of the memory dies 222 (such as DRAM dies) of the memory device 220. In one example, the memory device 250 comprises double data rate synchronous dynamic random-access memory (DDR SDRAM) or memory of similar or faster speed and/or similar or higher capacity. In one example, the memory device 250 is a lower power memory device than the memory dies 222.

The memory device 250 is optional and may be omitted from the electronic device 200. In the example of FIG. 2, the memory device 250 is mounted to the substrate 240. In other examples, the memory device 250 may be disposed on the interposer 230 or to another substrate that is connected to and/or mounted to the substrate 240. In one example, the memory device 250 is connected to the processing device 210 and/or the memory device 220 via vias and routings in the substrate 240 and/or the interposer 230.

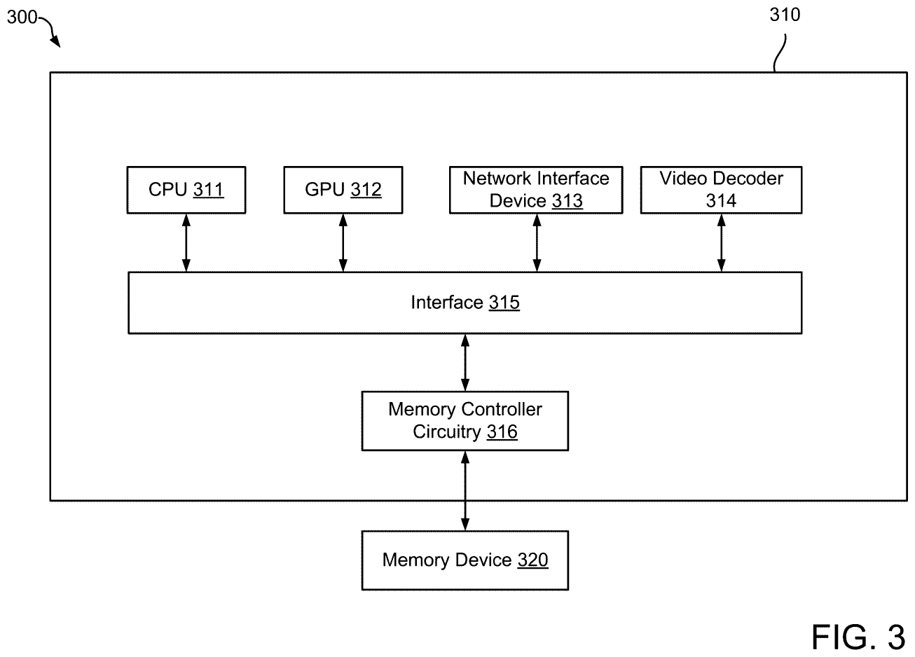

FIG. 3 illustrates a computer system 300. The computer system 300 includes one or more chips. The computer system 300 includes a host device 310 and a memory device 320. The host device 310 is connected to the memory device 320. In one or more examples, the host device 310 is an example of the host device 110 of FIG. 1. Further, the memory device 320 is an example of the memory device 120 of FIG. 1. In one or more examples, the host device 310 includes a central processing unit (CPU) 311, graphics processing unit (GPU) 312, network interface device 313, video decoder 314, interface 315, memory controller 316, and memory device 320. However, the computer system 300 is just one example of a computer system 300. In other examples, the computer system 300 may include fewer components than what is shown in FIG. 3. For example, the computer system 300 may not include the GPU 312, the network interface device 313, and/or the video decoder 314. In one or more examples, the computer system 300 may include additional devices than the ones shown in FIG. 3. Thus, FIG. 3 is just one example of components that can be included in a computer system 300.

The CPU 311 can represent any number of processors where each processor can include any number of cores. For example, the CPU 311 can include processors arranged in array, or the CPU 311 can include an array of cores. In one embodiment, the CPU 311 is an x86 processor that uses a corresponding complex instruction set. However, in other embodiments, the CPU 311 may be other types of CPUs such as an Advanced Reduced Set Instruction Computer (RSIC) Machine (ARM) processor.

The GPU 312 is an internal GPU 312 that performs accelerated computer graphics and image processing. The GPU 312 can include any number of different processing elements. In one embodiment, the GPU 312 can perform non-graphical tasks such as training an AI model or cryptocurrency mining.

The network interface device 313 allows for the computer system 300 to communicate over a network. The network may be a wired and/or wireless network.

The video decoder 314 can be used for decoding and encoding videos.

The memory controller 316 controls the memory device 320. The memory device 320 is described in greater detail with regard to the memory device 120 of FIG. 1. The memory device 320 may be included within a common chip with the CPU 311, the GPU 312, the network interface device 313, the video decoder 314, the interface 315, and/or the memory controller circuitry 316. In one or more examples, two or more of the CPU 311, the GPU 312, the network interface device 313, the video decoder 314, the interface 315, and the memory controller circuitry 316 are included in a common chip.

The CPU 311, the GPU 312, the network interface device 313, the video decoder 314, and the memory controller 316 are communicatively coupled using an interface 315. Put differently, the interface 315 permits the different types of circuitry in the computer system 300 to communicate with each other. For example, the CPU 311 can use the interface 315 to communicate with the memory controller 316, and the memory device 320.

In one example, the computer system 300 is part of a distributed computer system. In such an example, the computer system 300 is a server computer system. In such an example, the distributed computer system includes multiple computer systems that are configured similar to the computer system 300. In one or more examples, each of the computer systems are connected via a network (wireless or wired connections), and each of the computer systems include network interconnect circuitry that is used communicate with each other.

In one or more examples, an electronic device (e.g., the electronic device 100 of FIG. 1 or the electronic device 200 of FIG. 2) or a computer system (e.g., the computer system 300 of FIG. 3) performs a command and address parity checking function. Parity checking is used to detect errors within the command and address signals and/or the data signals. In one example, control circuitry (e.g., the control circuitry 122 of FIG. 1 or the control circuitry 226 of FIG. 2) receives an input signal (e.g., a command and address signal or another type of signal), generates a parity bit based on the bits of the input signal, and compares the determined parity bit to an expected parity bit (e.g., golden parity bit or reference parity bit) to determine if there is an error within the input signal. For example, if the determined parity bit differs from the expected parity bit, a parity error is determined. If the determined parity bit is the same as the expected parity bit, no parity error is determined. In one example, when a parity error is determined, the memory device (e.g., the memory device 120 of FIG. 1 or the memory device 220 of FIG. 2) outputs an error signal. The error signal may be output a clock period of a clock signal of the memory device 120 after the parity error is detected. In one example, the error signal is received by a host device (e.g., the host device 110 of FIG. 1). The host device receives the error signal and applies one or more error mitigation functions. For example, the host device may resend the signal associated with the determined error. However, such a parity detection and error signal reporting process is non-blocking as the memory device is not prevented from executing the command associated with the received signal regardless of the outcome of the parity check result.

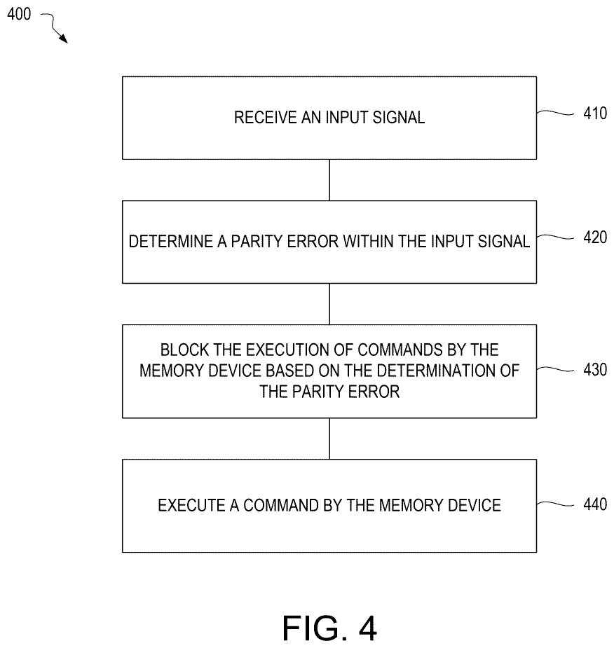

FIG. 4 illustrates a flowchart of a method 400 for detecting and mitigating parity errors associated with signals communicated to a memory device (e.g., the memory device 120). The method 400 blocks the memory device from executing a command associated with a signal (e.g., command and address signal) for which an error is detected. In one example, command blocking is enabled within the memory device until the expiration of a command blocking period and/or no error (e.g., not parity error) is determined.

At 410 of the method 400, an input signal is received. For example, a memory device (e.g., the memory device 120 of FIG. 1 or the memory device 220 of FIG. 2) receives the input signal. The input signal may be a command and address signal. In one example, the memory device receives the command and address signal from a host device (e.g., the host device 110 of FIG. 1). In one or more examples, the command and address signal indicates a read command or a write command and an associated address within the memory device. The command and address signal is received based on a clock signal (e.g., rising edges or falling edges of the clock signal) of the corresponding electronic device and/or memory device.

At 420 of the method 400, a parity error is determined within the input signal. In one example, control circuitry (e.g., the control circuitry 122 of FIG. 1 or the control circuitry 226 of FIG. 2) determines a parity value from the input signal. In one example, the parity of the input signal is determined based on the number of ones (or zeros) within the input signal. For example, the control signal determines a parity value of a command and address signal based on a number of ones (or zeros) within the command and address signal. The input signal (or command and address signal) may be communicated with a parity bit. In one example, the control circuitry XORs (or combines in some other way) the bits of the command and address signal.

The parity value of the input signal is compared to a known (expected or golden) parity value by the control circuitry. A parity error is determined based on the determined parity value of the input signal differing from the known parity value. In an example wherein the parity value of the input signal is the same as (e.g., matches) the known parity value, no parity error is determined.

At 430 of the method 400, commands are blocked from being executed by the memory device based on the determination of the parity error. In one example, the control circuitry (e.g., the control circuitry 122 of FIG. 1 and/or the control circuitry 226 of FIG. 2) blocks, prevents, the execution of commands by the memory device (e.g., the memory device 120 of FIG. 1 or the memory device 220 of FIG. 2) based on the determination of the parity error. Blocking the memory device from completing a commands, prevents the memory device from performing operations, or functions, associated with the commands. Blocking the memory device from performing command prevents the memory device from performing, executing, read commands, or write commands, among others. The memory device is blocked from executing the command associated with the signal for which a parity error was detected.

In one example, the memory circuitries (e.g., the memory circuitries 124) include memory elements that are disposed in rows and columns. The rows are coupled to a row bus and the columns are coupled to a column bus. In such an example, commands associated with the rows (and row bus) and the columns (and the column bus) are block from being executed (e.g., are not executed). The row bus is used to provide row commands to a row or rows of the memory elements within the memory circuitries. The column bus is used to provide column commands to a column or columns of the memory elements within the memory circuitries. Row commands may be row address commands and column command may be column address commands.

In one or more examples, the memory device is blocked from performing all commands during a command blocking period. The command blocking period corresponds to one or more periods of a clock signal of the memory device. The length of the command blocking period may differ between memory devices (e.g., different types of memory devices and/or configurations of memory devices). In one example, the length of the command blocking period allows for the memory device to complete any operations in progress before commands are blocked from being performed. In one example, the length of the command blocking period corresponds to a length of refresh period. The refresh period may be a refresh period for a row. In one example, the refresh period is a directed refresh management period used to refresh rows that are undergoing rowhammer protection. Rowhammer protection mitigates unauthorized access to the memory elements. In one example, the memory device is blocked from performing commands until a command and address signal is received and is determined to not include a parity error. In one or more examples, latency may exist within the memory device. The latency may be due to pipeline latency in the control circuitry 122 (e.g., parity error checking circuitry). The latency may be one or more clock cycles. In one example, the command, or commands, is held with a buffer (or another element), while the command, or commands, is checked for parity errors. A command is released when the command is determined to be error free. In another example, the command is blocked from being executed when an error is detected. Blocking a command prevents the command from being executed.

In one example, based on determining a parity error within the input signal, the control circuitry outputs an error signal to a host device (e.g., the host device 110 of FIG. 1). In one example, the error signal is driven high for one or clock periods, indicating that a parity error was determined. Based on receiving the error signal, the host device may resend the signal associated with the parity error or perform another error mitigation process.

The host device (e.g., the host device 110 of FIG. 1) may maintain a buffer storing outstanding transactions. Based on receiving the error signal, the host device may resend the outstanding transactions as command and address signal (e.g., input signal) to the memory device based on the order and/or age of the outstanding transactions within the buffer.

At 440, a command is executed by the memory device. In one example, the control circuitry (e.g., the control circuitry 122 of FIG. 1 or the control circuitry 226 of FIG. 2) receives a second input signal (e.g., a command and address signal) and controls the corresponding memory device (e.g., the memory device 120 of FIG. 1 or the memory device of FIG. 2) to execute the associated command. In one example, the second input signal is a read command signal. The control circuitry receives the input signal, outputs the read command signal and corresponding address to the memory circuitries 124. Data is obtained from the memory circuitries 124 based on the address of the command signal, and is output to a host device (e.g., the host device 110 of FIG. 1).

In one example, a parity error is determined in a following received input signal (or command and address signal). In such an example, the memory device is maintained in the command blocking period. In one example, when an additional parity error is determined (e.g., a parity error on a following or subsequent command and address signal), the command blocking period is restarted.

Blocking a memory device from performing commands when a parity error is determined improves the reliability of the corresponding electronic device or computer system. For example, based on the determination of a parity error, the host device is alerted of the parity error based on an error signal. The host device waits for the completion of a command blocking period before sending another command and address signal. As the command associated with the parity error is prevented from being completed, the host device does not determine that a fatal error has occurred, and is able to resend the commands associated with the parity error, improving the reliability of the corresponding electronic device and/or computer system.

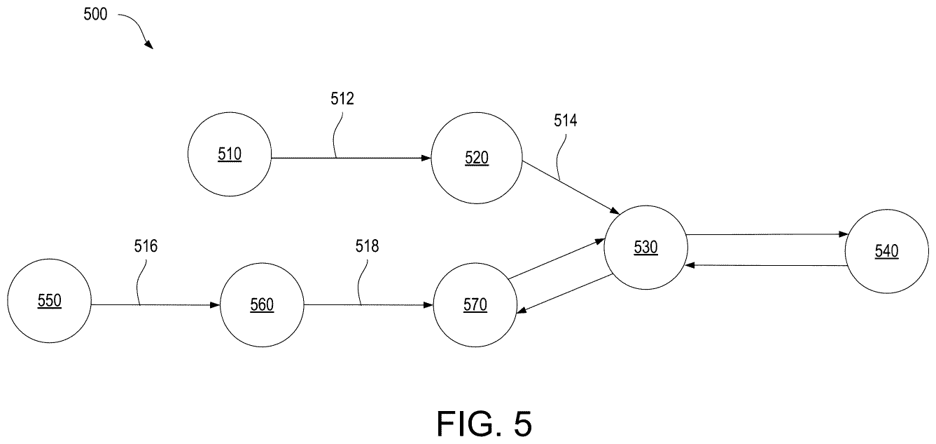

FIG. 5 illustrates a state diagram 500 for a memory device (e.g., the memory device 120 of FIG. 1 or the memory device 220 of FIG. 2). State 510 corresponds to any state of the memory device. For example, the state 510 may be an idle state, an active state, a low power state, or a power-down state among others. At 512, a command and address signal is received, and a parity error is determined in the command and address signal. Based on receiving the command and address signal and determining that the parity error within the command and address signal, the memory device enters state, 520 parity blocking state or command blocking state. In the parity blocking state 520, the memory device is blocked (e.g., prevented) from executing commands. In one example, the parity memory device is blocked from executing commands for a blocking period 514 (e.g., one or more cycles of a clock signal of the memory device). The memory device enters the state 530, a self-refresh state, based on the expiration of the blocking period 514. During the self-refresh state 530, the memory device refreshes the data stored within the memory circuitries (e.g., the memory circuitries 124 of FIG. 1) of the memory device. In one example, before the self-refresh sate 530 is entered, the memory device completes any operation that is already in progress. In one or more examples, additionally, or alternatively, the memory device closes any open pages before entering the self-refresh state 530. Open pages refer row buffer strategy to maintain active activate rows within the memory circuities that are being read from. Closing page closes the corresponding active memory elements. Further, the memory device may additionally, or alternatively, reset the bank counter before entering the self-refresh state 530. In one example, the memory elements (e.g., memory elements 130) of the memory circuitries of the memory devices are arranged in banks. Resetting the bank counter resets the counter used during refresh of the banks such that the refresh process is restarted and completed for each of the banks. At the completion of the self-refresh state 530, the memory device enters the training state 540. The training state 540 may be used to train the command bus of the memory device. The command bus is used to communicate command and address signals between the host device and the memory device. Training the command bus ensures that the memory device is able to properly receive and execute (e.g., understand) the commands received by the memory device. Training the command bus includes input data to the memory device and reading the data to compare the read data to the expected data. Differences between the read data and the expected data are adjusted by the host device (e.g., the host device 110) to ensure that command and address signals are properly received by the memory device.

In one example, commands are blocked from being performed until the self-refresh state 530 is entered. In one or more examples, commands are block from being performed until the self-refresh state 530 and the training state 540 are entered.

State 550 is a power on state for the memory device. At 516, based on a reset signal having low value, the memory device enters the reset state 560. Further, at 518 based on the reset signal having a high value, the memory device enters the bank idle state 570. From the bank idle state 570, the memory device enters and leaves the self-refresh state 530 based on associated commands. In one example, once in self-refresh state 530, the memory device is enters the bank idle state 570 or the training state 540.

The parity error detection and mitigation process as is described above improves the reliability of a memory device, and corresponding computer system, by blocking the execution of commands by the memory device. Accordingly, when a parity error within a command and address signal is determined (e.g., detected), the memory device enters a command blocking period, blocking the execution of commands by the memory device during the command blocking period. Blocking the memory device from executing commands, mitigates errors within the memory device, and/or corresponding computer system, improving the reliability of the memory device, and the corresponding computer system.

In one example a memory device includes memory circuitry configured to store data, and control circuitry connected to the memory circuitry. The control circuitry receives a first signal from a host device, and block execution of commands to the memory circuitry based on determining a parity error within the first signal. In one example, blocking execution of the commands includes placing the memory device in a command blocking state. In one example, the memory device is placed in a self-refresh state at completion of the command blocking state. In one example, the control circuitry blocks execution of commands by the memory device during a command blocking period. The command blocking period has a length of one or more periods of a clock signal of the memory device. In one example, the memory circuitry includes at least one selected from the group consisting of a row bus and a column bus, and blocking the execution of the commands blocks commands associated with the at least one selected from the group consisting of a row bus and a column bus. In one example, determining the parity error within the first signal comprises determining a parity value based on bit values of the first signal, and comparing the parity value to an expected value. In one example, the control circuitry is further configured to output an error signal to the host device. The host device sends a second signal based on receiving the error signal.

In one example, a method includes receiving, at a memory device, a first signal from a host device, determining, by the memory device, a parity error within the first signal, and blocking execution of commands by the memory device based on determining the parity error. In one example, blocking execution of the commands comprises placing the memory device in a command blocking state. In one example, the memory device is placed in a self-refresh state at completion of the command blocking state. In one example, execution of commands by the memory device is blocked during a command blocking period. The command blocking period having a length of one or more periods of a clock signal of the memory device. In one example, the memory device includes at least one selected from the group consisting of a row bus and a column bus, and blocking the execution of the commands blocks commands associated with the at least one selected from the group consisting of a row bus and a column bus. In one example, determining the parity error within the first signal comprises determining a parity value based on bit values of the first signal, and comparing the parity value to an expected value. In one example, the method further comprises outputting an error signal to the host device, wherein the host device communicates a second signal based on receiving the error signal.

In one example, an electronic device includes a host device, and a memory device connected to the host device. The memory device includes memory circuitry to store data, and control circuitry connected to the memory circuitry. The control circuitry receives a first signal from the host device, and block execution of commands to the memory circuitry based on determining a parity error within the first signal. In one example, blocking execution of the commands comprises placing the memory device in a command blocking state. In one example, the memory device is placed in a self-refresh state at completion of the command blocking state. In one example, the control circuitry blocks execution of commands by the memory device during a command blocking period, the command blocking period having a length of one or more periods of a clock signal of the memory device. In one example, the memory circuitry includes at least one selected from the group consisting of a row bus and a column bus, and blocking the execution of the commands blocks commands associated with the at least one selected from the group consisting of a row bus and a column bus. In one example, determining the parity error within the first signal comprises determining a parity value based on bit values of the first signal, and comparing the parity value to an expected value.

In one or more examples, a memory device includes memory circuitry and control circuitry. The memory circuitry stores data. The control circuitry is connected to the memory circuitry. The control circuitry receives a first signal from a host device, and blocks execution of commands to the memory circuitry based on a parity error within the first signal. In one or more examples, blocking execution of the commands comprises placing the memory device in a command blocking state. In one or more examples, the memory device is placed in a self-refresh state at completion of the command blocking state. In one or more examples, the control circuitry blocks execution of commands by the memory device during a command blocking period. The command blocking period has a length of one or more periods of a clock signal of the memory device. In one or more examples, the memory circuitry includes at least one selected from the group consisting of a row bus and a column bus, and blocking the execution of the commands blocks commands associated with the at least one selected from the group consisting of a row bus and a column bus. In one or more examples, the control circuitry compares the parity value to an expected value to determine the parity error within the first signal, wherein the parity value is based on bit values of the first signal. In one or more examples, the control circuitry is further outputs an error signal to the host device. The host device sends a second signal based on receiving the error signal.

In one or more examples, a method includes receiving, at a memory device, a first signal from a host device, and blocking execution of commands by the memory device based on a parity error within the first signal. In one or more examples, blocking execution of the commands includes placing the memory device in a command blocking state. In one or more examples, the memory device is placed in a self-refresh state at completion of the command blocking state. In one or more examples, execution of commands by the memory device is blocked during a command blocking period, the command blocking period having a length of one or more periods of a clock signal of the memory device. In one or more examples, the memory device includes at least one selected from the group consisting of a row bus and a column bus, and blocking the execution of the commands blocks commands associated with the at least one selected from the group consisting of a row bus and a column bus. In one or more examples, comparing the parity value to an expected value to determine the parity error within the first signal, the parity value based on bit values of the first signal. In one or more examples, an error signal is output to the host device, wherein the host device communicates a second signal based on receiving the error signal.

In one or more examples, an electronic device includes a host device and a memory device connected to the host device. The memory device includes memory circuitry and control circuitry. The memory circuitry stores data. The control circuitry is connected to the memory circuitry. The control circuitry receives a first signal from the host device, and blocks execution of commands to the memory circuitry based on a parity error within the first signal. In one or more examples, blocking execution of the commands comprises placing the memory device in a command blocking state. In one or more examples, the memory device is placed in a self-refresh state at completion of the command blocking state. In one or more examples, the control circuitry is configured to block execution of commands by the memory device during a command blocking period, the command blocking period having a length of one or more periods of a clock signal of the memory device. In one or more examples, the memory circuitry includes at least one selected from the group consisting of a row bus and a column bus, and blocking the execution of the commands blocks commands associated with the at least one selected from the group consisting of a row bus and a column bus. In one or more examples, the control circuitry compares the parity value to an expected value to determine the parity error within the first signal, the parity value is based on bit values of the first signal.

While the foregoing is directed to specific examples, other and further examples may be devised without departing from the basic scope thereof, and the scope thereof is determined by the claims that follow.

What is claimed is:

1. A memory device comprising:
memory circuitry configured to store data; and
control circuitry connected to the memory circuitry, the control circuitry configured to:
receive a first signal from a host device; and
block execution of commands to the memory circuitry based on a parity error within the first signal.

2. The memory device of claim 1, wherein blocking execution of the commands comprises placing the memory device in a command blocking state.

3. The memory device of claim 2, wherein the memory device is placed in a self-refresh state at completion of the command blocking state.

4. The memory device of claim 1, wherein the control circuitry is configured to block execution of commands by the memory device during a command blocking period, the command blocking period having a length of one or more periods of a clock signal of the memory device.

5. The memory device of claim 1, wherein the memory circuitry includes at least one selected from the group consisting of a row bus and a column bus, and blocking the execution of the commands blocks commands associated with the at least one selected from the group consisting of a row bus and a column bus.

6. The memory device of claim 1, wherein the control circuitry compares the parity value to an expected value to determine the parity error within the first signal, wherein the parity value is based on bit values of the first signal.

7. The memory device of claim 1, wherein the control circuitry is further configured to output an error signal to the host device, wherein the host device sends a second signal based on receiving the error signal.

8. A method comprising:
receiving, at a memory device, a first signal from a host device; and
blocking execution of commands by the memory device based on a parity error within the first signal.

9. The method of claim 8, wherein blocking execution of the commands comprises placing the memory device in a command blocking state.

10. The method of claim 9, wherein the memory device is placed in a self-refresh state at completion of the command blocking state.

11. The method of claim 8, wherein execution of commands by the memory device is blocked during a command blocking period, the command blocking period having a length of one or more periods of a clock signal of the memory device.

12. The method of claim 8, wherein the memory device includes at least one selected from the group consisting of a row bus and a column bus, and blocking the execution of the commands blocks commands associated with the at least one selected from the group consisting of a row bus and a column bus.

13. The method of claim 8, wherein comparing the parity value to an expected value to determine the parity error within the first signal, wherein the parity value is based on bit values of the first signal.

14. The method of claim 8 further comprising outputting an error signal to the host device, wherein the host device communicates a second signal based on receiving the error signal.

15. An electronic device comprising:
a host device; and
a memory device connected to the host device, the memory device comprising:
memory circuitry configured to store data; and
control circuitry connected to the memory circuitry, the control circuitry configured to:
receive a first signal from the host device; and
block execution of commands to the memory circuitry based on a parity error within the first signal.

16. The electronic device of claim 15, wherein blocking execution of the commands comprises placing the memory device in a command blocking state.

17. The electronic device of claim 16, wherein the memory device is placed in a self-refresh state at completion of the command blocking state.

18. The electronic device of claim 15, wherein the control circuitry is configured to block execution of commands by the memory device during a command blocking period, the command blocking period having a length of one or more periods of a clock signal of the memory device.

19. The electronic device of claim 15, wherein the memory circuitry includes at least one selected from the group consisting of a row bus and a column bus, and blocking the execution of the commands blocks commands associated with the at least one selected from the group consisting of a row bus and a column bus.

20. The electronic device of claim 15, wherein the control circuitry compares the parity value to an expected value to determine the parity error within the first signal, wherein the parity value is based on bit values of the first signal.
